(19) United States
(12) Patent Application Publication
(10) Pub. No.: US 2007/0226734 A1
(43) Pub. Date: Sep. 27, 2007

(54) Auxiliary display gadget for distributed content

(75) Inventors: Yu-Kuan Lin, Seattle, WA (US); Sriram Viji, Seattle, WA (US); Andrew J. Fuller, Redmond, WA (US); Matthew P. Rhoten, Kirkland, WA (US); Alex Z. S. D'Angelo, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/367,997

(22) Filed: Mar. 3, 2006

(51) Int. Cl. G06F 9/445

(52) U.S. Cl. 717/177

(57) ABSTRACT

Described is a technology by which a specific gadget program is installed (e.g., created) on a main host computer system that receives data (e.g., an RSS feed) from a distribution source, in which the feed data contains the information needed to install the gadget. Once installed, gadget is then used to receive content from its corresponding data source and provide the content for display on an auxiliary display device. The feed data may include metadata such as a gadget-related enclosure, from which the installer may register information corresponding to the metadata in a registry or the like, and associate the gadget with one or more particular auxiliary displays. By processing the metadata, the other gadget is installed and then run as needed to handle content data from the corresponding data source, in order to render content on an auxiliary display.

### BACKGROUND

In contemporary (e.g., Windows® Vista™-based) computer systems, users are able to view and generally interact with selected content on a small auxiliary display device coupled to or integrated into a main host computer system. To this end, an auxiliary display screen along with an operating system-provided platform (referred to as an auxiliary display platform, or a Windows® SideShow™ platform), enables developers and authors to present content to users. This allows the user to view the content even when the main host computer system is in a reduced power state (e.g., ACPI S3 sleep state), or even turned off.

To provide data for display, the auxiliary display platform uses gadgets, comprising small plug-in type computer programs that run on the main host system, and which obtain and process content from another application program or data source. In most scenarios, gadgets are pre-installed, proprietary programs, which restrict gadget-provided content to what is locally available on the user's personal computer.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a main host computer system that is coupled to one or more auxiliary display devices, and that includes a component that processes data received from a source, such as an RSS feed. The data includes metadata that corresponds to information for handling content associated with the source data. The metadata is used to enable a gadget to handle the content, which includes providing at least part of the content (e.g., in a suitable format for consumption by an auxiliary device) to an auxiliary display platform. Enabling the gadget includes installing the gadget if necessary, e.g., by writing information corresponding to the metadata into a system registry, and loading and running the gadget.

By having a gadget obtain the received data and process its metadata, another gadget that is capable of handling the content associated with the received data may be installed (as necessary), and then run so as to receive content from the data source corresponding to that other gadget. The other gadget then outputs data that represents at least part of the content for consumption by the auxiliary display device, which may include converting the content from one format to another format for consumption. It is also possible for the RSS gadget to create virtual gadgets such that the RSS gadget receives the content from the source, but displays it in the form of a separate, “virtual” gadget, rather than having the second gadget handle its own data subscription.

Aspects of the subject matter may be implemented in a system, such as a system having a platform (e.g., an RSS platform) that receives distributed data from data distribution sources. A distribution (e.g., RSS) gadget coupled to the platform processes the distributed data, and as necessary, an installer mechanism associated with the distribution gadget may install a specific gadget as needed for the specific data source that provided the gadget-related information. The newly-installed specific gadget provides the content received from the specific data source to an auxiliary display platform.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment into which various aspects of the present invention may be incorporated.

FIG. 2 is a block diagram generally representing example components for handling an RSS feed via a gadget created from the feed metadata.

FIG. 3 is a block diagram generally representing an example implementation by which RSS data is fed to an auxiliary display device.

FIG. 4 is a representation of a gadget being created or loaded and run to handle content from an RSS feed.

FIG. 5 is a flow diagram generally representing example steps for processing RSS data to enable a gadget to handle RSS content from an RSS source.

FIG. 6 is a flow diagram generally representing example steps performed by a gadget once enabled to handle RSS content from an RSS source.

### DETAILED DESCRIPTION

Exemplary Operating Environment

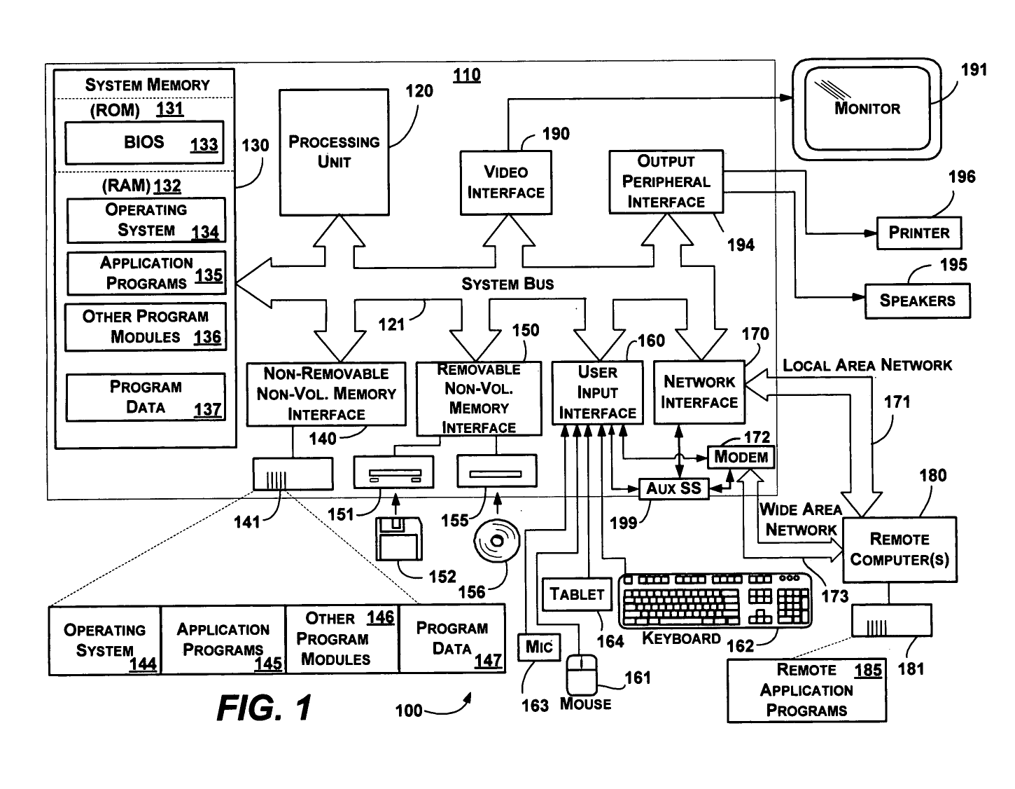

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, described above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It may be appreciated that the network connections shown are exemplary and other means of establishing a communications link between the computers may be used.

An auxiliary display subsystem 199 may be connected via the user interface 160 to allow data such as program content, system status and event notifications to be provided to the user, even if the main portions of the computer system are in a low power state. The auxiliary display subsystem 199 may be connected to the modem 172 and/or network interface 170 to allow communication between these systems while the main processing unit 120 is in a low power state.

Auxiliary Display Gadget For Distributed Content

Various aspects of the technology described herein are directed towards obtaining and processing content to be displayed on an auxiliary display device coupled to a main host computer system. In general, much of the description herein is directed towards a particular example in which the content is obtained from a remote data source using RSS (Really Simple Syndication) technology, where RSS technology generally refers to Web syndication/content distribution using one or more XML-based file formats. RSS is typically used by news websites and web logs (blogs) to distribute their content, but also may be used for other purposes, including marketing, bug reporting, or any other activity involving periodic updates or publications.

RSS technology allows Internet users to subscribe (often for no cost) to RSS feeds from websites, typically websites that frequently change content. In general, each such site provides the data to distribute on demand, where the data comprises content along with some metadata, often including links to other content. This data is delivered to subscribers as an XML file referred to herein as RSS data or RSS feed, but in other contexts alternatively may be referred to as a web feed, RSS stream, or RSS channel. RSS data may include attached multimedia files.

As will be understood, however, the technology described herein is not limited to any particular data source and/or data format, or even RSS technology, and may be used with local as well as remote data. Moreover, the technology described herein is not limited to any particular types of auxiliary devices, but rather includes devices not conventionally thought of as devices that are “computer-system” coupled devices, such as television sets, audio receivers, audio/video recorders, telephones, a separate computer, a mobile communications device, a secondary display screen with actuators, a watch, a wall (e.g., kitchen) display, a display screen, a digital picture frame, a clock, a radio, a media player, a device embedded within or using the main display of a consumer electronics device, automotive, transportation or other vehicular units, keyboards or other input devices of the main computer system, a pager, a personal digital assistant, and so forth. As such, the present invention is not limited to the examples, structures or functionality described herein; rather, any of the examples, structures or functionality described herein are non-limiting, and the present invention may be used various ways that provide benefits and advantages in computing and content handling in general.

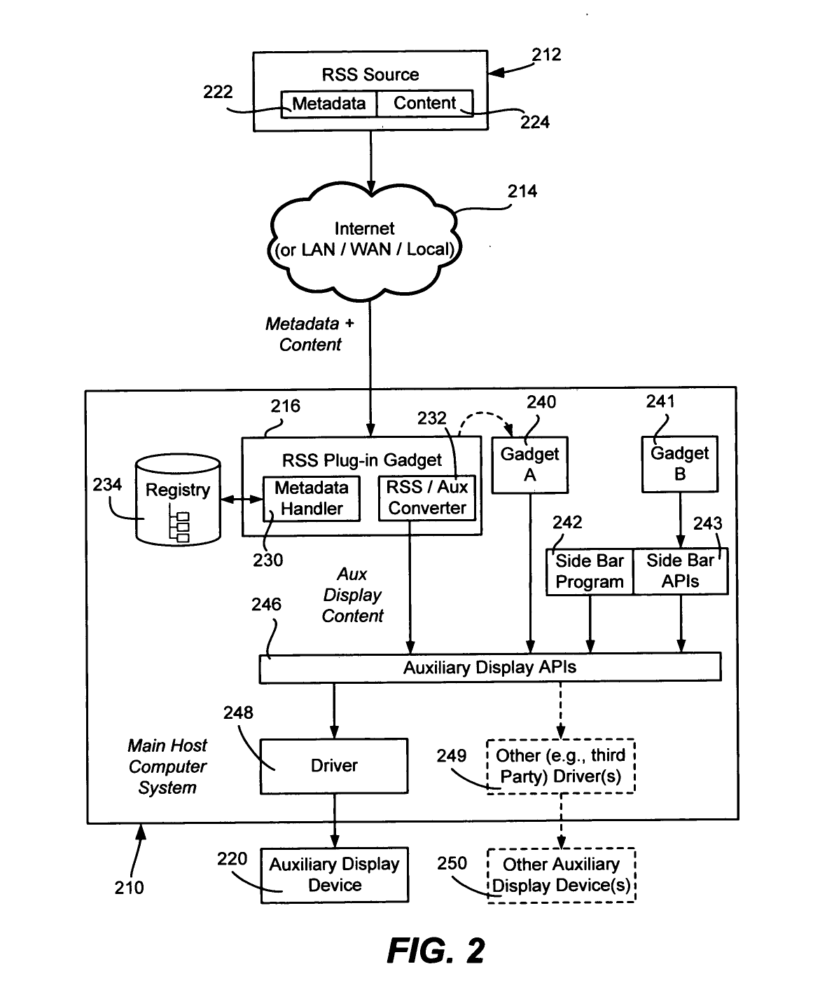

Turning to FIG. 2 of the drawings, there is shown an example block diagram including various components by which a main computer system 210 (such as one based on the computer 110 of FIG. 1) receives data from an RSS source 212, such as via the Internet 214. Note that the data may alternatively be obtained via some other means, such as via a LAN or other WAN connection, or even local data source, such as if downloaded to a file/cache/buffer.

As described below, data from the RSS source 212 data is received at an RSS gadget 216. In general, the gadget 216 comprises program code running on the main host computer system that registers with the auxiliary display platform to send data to one or more auxiliary display devices; the gadget may be enabled or disabled from the control panel.

The gadget 216 processes received data for content consumption by (typically display on) an auxiliary device 220. As also described below, this processing includes handling the metadata 222 accompanying the RSS feed. To this end, the RSS gadget 216 includes or is otherwise associated with a metadata handler mechanism 230. Processing also may include converting, as represented by the RSS/Aux converter 232, the RSS content 224 to a format that the auxiliary display device 220 (e.g., part of the auxiliary display subsystem 199 of FIG. 1) can handle. One such format is referred to as simple content format (SCF), which comprises a basic data format that auxiliary display devices should be able to display, and includes formatting for communicating menu, picture and notification data.

To facilitate content receipt, the source 212 of the RSS data provides information about the content 224 in the metadata 222. More particularly, rather than needing a dedicated gadget on the host computer system to handle its content, the metadata handler 230 on the RSS gadget 216 will handle data from various sources, and differentiate the data based upon the metadata. As a result, this technology enables content providers to efficiently syndicate auxiliary display-destined content to a broad, potentially unlimited, audience over the web without requiring proprietary software on each recipient's device.

More particularly, as a special case of data distribution/management, instead of only delivering content, content providers can use RSS to distribute auxiliary display-specific data and create new gadgets. For example, when a user subscribes to an RSS feed with this special auxiliary display data payload, the RSS gadget 216 may utilize this data to create a new, separate auxiliary display gadget, such as “Gadget A” 240 of FIG. 2. Once the new gadget 240 has been created, the RSS gadget acts as a “master” gadget to manage the newly created, “virtual” gadget, as well as to manage the data for the device coming from the subscribed RSS feed; (essentially the RSS gadget performs the data management, while giving the appearance of a separate gadget). Note that although not explicitly shown in FIG. 2, the Gadget A may alternatively receive and/or convert received RSS content into an auxiliary device-compatible format, such as the simple content format. The gadget 216 thus manages, customizes, and distributes RSS-delivered content from a source to (or through) the user's host computer system, and to the user's auxiliary display device or devices.

In one example implementation, the first time that RSS data from a site such as the source 212 is downloaded, information corresponding to the metadata 222 is written to the host system's registry 234, (e.g., assuming the user and/or policy allows such an action). Note that any metadata that already has its corresponding information in the registry 234 need not be rewritten on subsequent feeds; instead the existing information in the registry 234 may be used to determine how to handle the associated RSS content 224 with respect to an auxiliary device's display of that content. Thereafter, some form of the content 224 can be provided (e.g., via the created gadget 240) to the auxiliary display device 220. As a result, from the user's perspective, discovering and installing a new gadget is as simple as subscribing to a RSS feed.

For completeness, FIG. 2 shows other gadgets that may be used with the auxiliary display platform, including “Gadget B” 241; note that Gadget B 241 works with a side bar program 242 and/or related APIs 243 respectively. Gadget B 241 uses the Sidebar APIs 243 to communicate through APIs 246 to a driver 248 for the auxiliary device 220.

Also for completeness, FIG. 2 shows that one or more other drivers 249 and auxiliary devices 250 may be present with a given system 210. Although the other driver(s) 249 and auxiliary device(s) 250 are shown via a dashed block to indicate that they are optional, it should be noted that the auxiliary device 220 is also optional, as a user may only have one other auxiliary device 250 with, for example, a third party driver 249. Examples of one such device represented by the auxiliary device 220 and/or the dashed block 250 include an enhanced display, generally comprising an auxiliary display device that runs SPOT (Smart Personal Object Technology) firmware and enhanced rendering code, a basic display, which is essentially an auxiliary display device that runs any other custom firmware but is capable of acting as an auxiliary display, e.g., a cell phone, and a single (or two, three, and so forth) line display, comprising an auxiliary display that is capable of displaying a very limited number (e.g., one or two lines of text) and contains essentially no image support. Other types of displays include an attached display/edge display/lid-top display, referring generally to an auxiliary display device of a type that is physically located on the body of a notebook personal computer or the like, e.g., on the top of the lid, a remote display comprising an auxiliary display that is not physically located on the host computer and communicates with the host computer through a wired or wireless a network protocol, and a “virtual” auxiliary display, generally comprising a display that presents auxiliary content within some area of a main display of the computer system. Thus, although the auxiliary devices 220 and 259 represented in FIG. 2 are shown as being external and coupled to the main host computer system 210, (possibly selectively coupled), it is understood that such devices may or may not be physically attached or otherwise detachable from the main host computer system 210.

Note that most RSS content is HTML-formatted text, however, RSS 2.0 provides for the embedding of other data such as multimedia content via <enclosure> tags, wherein an <enclosure> comprises an optional sub-element of an <item>. RSS enclosure types are defined by standard MIME types. For example, one implementation of an auxiliary display platform supports images using simple content format on enhanced displays, e.g., such as in jpg, gif, and bmp formats. For richer media scenarios, other media may be enabled, e.g., mpeg/wma for audio, wmv/avi/mpeg for video.

In RSS-related markup, an <enclosure> has a number of attributes, such as a URL that specifies where the enclosure is located, a length that specifies its size (e.g., in bytes), and a type that specifies what its type is, e.g., a standard MIME type. The URL may be an http URL, for example:

<enclosure
url=“http://www.scripting.com/mp3s/weatherReportSuite.mp3”
length=“12216320” type=“audio/mpeg” />

The RSS gadget can request the RSS platform to download the enclosure when it belongs to a recognized type. Once the enclosure has been downloaded, the gadget acquires the enclosed file from the RSS platform directly. Alternatively, the RSS gadget can download the enclosure itself, by use of the URL attribute in the enclosure markup.

Because there is no restriction on types of RSS payloads, content providers and software vendors are able to distribute virtually any type of data over the web to user's auxiliary display devices, including various content such as stock quotes and music. Rich media also may be delivered, making possible scenarios such as a wireless digital photo frame that automatically displays pictures from a user's subscribed blogs, or a media player that automatically downloads a user's favorite podcasts and news articles, or other scenarios.

Other example scenarios are directed towards, but not limited to, blog/RSS consumption (reading), blog/RSS creation (blogging), digital photo frames, podcasts, installing new gadgets using RSS, and Sidebar integration. For example, consider one user that listens to his audio player while commuting. In addition to listening to his music, he can use his audio player or other media device to download podcasts, photos, and RSS feeds while docked. He can then consume it while commuting. The device automatically picks up the right feeds to which he has he subscribed via an RSS platform feed list, e.g., he may subscribe to photos from a subset of friends, and/or possibly short video clips taken from mobile phones, and the RSS gadget will automatically synchronizes the content when the device is docked.

With respect to blogging, a mobile device (e.g., Smartphone) may have small panel for reading as well as for thumbpad input. The above consumption examples apply, but in addition, the user can additionally create content, e.g., by taking pictures, writing to a blog, and/or blogging content via the user's blog mechanism. Using an RSS enclosure, the user may create a photo feed directly distributed to a certain group, along with accompanying/explanatory text. For devices not having wireless capabilities, blog content may be cached for synchronization with an RSS engine when docked.

A digital photo frame may also receive content to which it is subscribed. For example, an auxiliary display digital photo frame may be wirelessly connected to a personal computer, and, loaded with an automatically-installed RSS gadget that picks up photos via RSS feeds, the computer pushes the photos to the photo frame. The photo frame may automatically display the newest photos and cycle through them periodically to keep them fresh.

Podcasts are another scenario that may be facilitated via an RSS podcast feed. To this end, a user may configure podcasts to be synchronized to a device, e.g., using an auxiliary gadget property page from the auxiliary display's control panel applet. When the user subscribes to the feed, the auxiliary gadget strips the enclosed podcasts from the RSS feed. Each time the device is docked, the gadget synchronizes the podcasts onto it, for later listening.

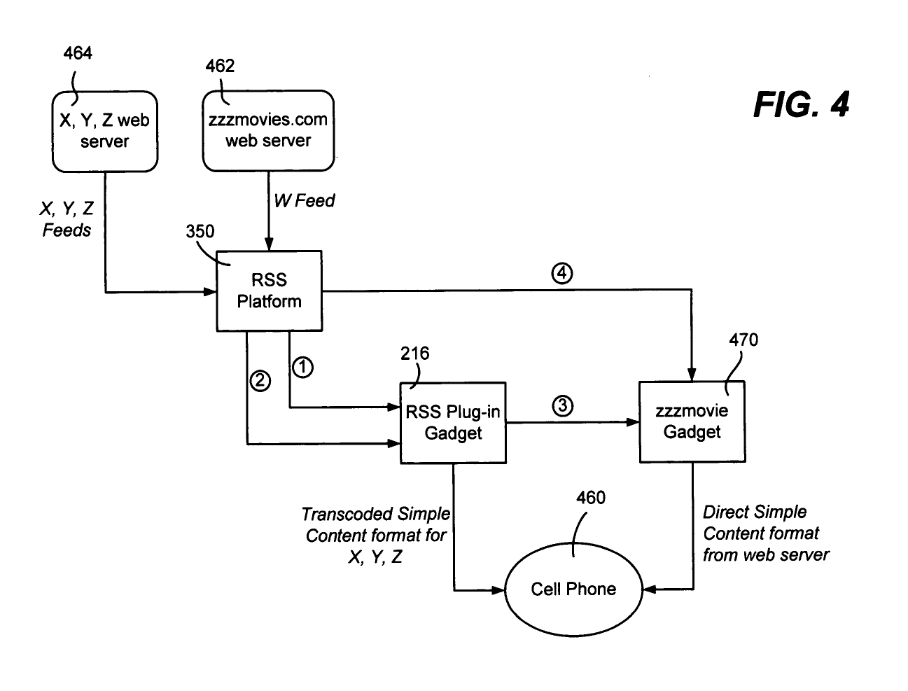

As described herein, new gadgets may be installed using RSS. For example, as described below with reference to FIG. 4, a site such zzzmovies.com may offer an RSS movie information feed. When a user subscribes to the feed, the auxiliary RSS gadget 216 detects that zzzmovies.com distributes a special movie information gadget that enables auxiliary displays to show movie information from the feed, including schedules, ticket availability, and reviews. Instead of requiring users to separately download and install such a gadget, the RSS gadget 216 (or another entity, such as a control panel applet) automatically installs a new movie information gadget, typically following a prompt and/or other policy check. The RSS gadget 216 configures the movie gadget to only function on supported devices, e.g., the movie gadget will not show up on a single-line keyboard auxiliary display, but will show up on a cell phone screen.

In this manner, the RSS gadget 216 enables users to consume (and create) content on portable devices in various media formats, including audio (e.g., podcasts), photos, text (e.g., blogs), and so forth using the auxiliary display platform. As a result, users are able to browse subscribed feeds, listen to podcasts, view photos/videos and perform similar tasks via their auxiliary display devices. Note that this may be accomplished with stand-alone RSS devices that consume/create content, or by using existing portable devices such as audio players to consume multimedia content.

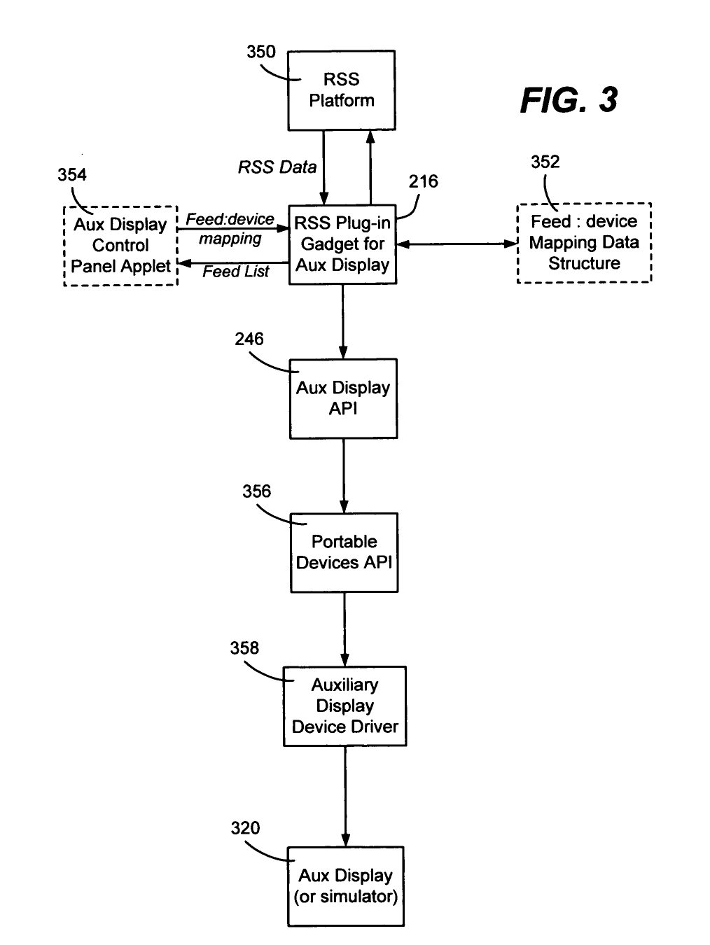

Turning to a more specific example implementation, as generally represented in FIG. 3, an RSS platform 350 provides the RSS data to the RSS gadget (for auxiliary displays) 216. In one specific example implementation, a distribution vehicle (e.g., a browser such as an Internet Explorer-based browser) performs a setup operation that registers the RSS feed platform so that an application or user need not have to do so. The RSS Feed Platform may be implemented as one or more Win32 COM APIs located in a dynamic link library, e.g., msfeeds.dll.

RSS feeds may be arranged as a set of folders and feeds within folders, such as the way that the arrangement of a browser component's favorites is stored. Note that the folder and feed order is typically not maintained in a system feed list, but rather, in one example implementation, (like a browsers favorite folders and sites), the operating system/browser component and an RSS explorer program share a set of registry keys to store the order of folders and feeds within folders. The RSS gadget 216 reads these registry keys for the folder and feed order; an example registry key for storing the order of subscriptions in the system feed list is HKEY_CURRENT_USER\Software\Microsoft\Windows\CurrentVersion\Explorer\MenuOrder\Feeds.

Note that a user may have multiple auxiliary devices, and thus may desire that a specific feed be mapped to a specific device. For example, due to a given device's limitations, the feeds that can be supported by that device may be only a subset of the user's total subscribed feeds, e.g., some simple content format-capable devices may have form factors that will produce poor user experiences when trying to render RSS feeds, and users should be able to turn off feeds for such devices. Further, for usability reasons, users may not want to consume all feeds on a single device, since a user may have feeds that number in the hundreds. Also for specific media types, such as photos, users may only choose to consume feeds from specific sources.

To enable users to associate specific feeds with specific auxiliary devices, as represented in FIG. 3 a feeds-versus-devices (Feeds:Devices) table 352 or similar data structure may be created. To create the feeds-versus-device structure 352, such as via an auxiliary display's control panel applet 354's property page, in one implementation the platform includes a new property, e.g., AUX_CAPABILITY_DEVICE_NAME, to each device's capability definition. The following device capabilities may be specified, with the addition of DEVICE_NAME:

| | | | | PROPVARIANT |
|---|---|---|---|---|
| Capability | GUID Value | PID | Data Type | Type |
| DEVICE_ID | {8ABC88A8-857B-4ad7- | 1 | GUID | VT_CLSID |
| | A35A-B5942F492B99} | | | |
| SCREEN_TYPE | {8ABC88A8-857B-4ad7- | 2 | SCREEN_TYPE | VT_I4 |
| | A35A-B5942F492B99} | | | |
| SCREEN_WIDTH | {8ABC88A8-857B-4ad7- | 3 | UINT16 | VT_UI2 |
| | A35A-B5942F492B99} | | | |
| SCREEN_HEIGHT | {8ABC88A8-857B-4ad7- | 4 | UINT16 | VT_UI2 |
| | A35A-B5942F492B99} | | | |
| COLOR_DEPTH | {8ABC88A8-857B-4ad7- | 5 | UINT16 | VT_UI2 |
| | A35A-B5942F492B99} | | | |
| COLOR_TYPE | {8ABC88A8-857B-4ad7- | 6 | COLOR_TYPE | VT_I4 |
| | A35A-B5942F492B99} | | | |
| DATA_CACHE | {8ABC88A8-857B-4ad7- | 7 | BOOL | VT_BOOL |
| | A35A-B5942F492B99} | | | |
| DEVICE_NAME | {8ABC88A8-857B-4ad7- | 8 | Any | Any |
| | A35A-B5942F492B99} | | suitable, | suitable, |
| | | | e.g., CHAR* | e.g., |
| | | | | VT_CHAR |

The RSS gadget 216 may use the ISideShowCapabilitiesCollection interface to enumerate the subset of currently connected auxiliary devices on a user's system. When the gadget queries for each device's properties, the gadget can then acquire a friendly name for the device (from DEVICE_NAME above), and render a table or the like that allows a user to associate specific feeds with a specific device (or devices), e.g., in a user interface of the control panel applet 354.

| interface ISideShowCapabilitiesCollection : IUnknown | |
|---|---|
| { | |
| HRESULT GetCount( | |
| [out] | DWORD * out_pdwCount |
| ); | |
| HRESULT GetAt( | |
| [in] | DWORD in_pdwIndex, |
| [out] | ISideShowCapabilities ** out_ppDevice |
| ); | |
| }; | |

| interface ISideShowCapabilities : IUnknown | |
|---|---|
| { | |
| HRESULT GetCapability( | |
| [in] | REFPROPERTYKEY in_keyCapability, |
| [in, out] | PROPVARIANT * out_pValue |
| ); | |
| }; | |

for Example:
In General, the Gadget Will do the Following:
1. Set BOOL *out_pfDifferentiateContent from IAuxiliaryDisplayContent::DifferentiateContent to TRUE
2. When it calls ISideShowContentManager::Add( ) to add new content, the platform will call back with a separate GetContent( ) from the ISideShowContent interface for each device.
3. Then with each GetContent( ) call, the gadget can then use the IAuxiliaryDisplayCapabilities pointer to query for each device's friendly name. Combining the device names with the internally stored feeds-to-devices mapping will return only specific device-based feeds.

The RSS gadget 216 may gracefully fail the ISideShowContent::GetContent( ) callback to return only specific feeds based on the device. Note that this is a callback because the gadget calls ISideShowContentManager::Add, and the content manager calls the gadget back on its ISideShowContent interface.

Once associations have been made in some way, e.g., by default as modified via the control panel applet's user interface, the RSS gadget 216 stores this feed-to-device structure (e.g., graph) 352 so that the gadget will later be able to access the store 352 to determine which feeds to push to which devices. For example, one user may want to see/hear all music-related feeds on a music player device, but see urgent work feeds on a cell phone. Note that the RSS gadget 216 (or a virtual gadget created thereby) may customize the simple content format content for each device to account for the different feeds. Because the user may update each association from the auxiliary display's control panel applet 354 at any time, the RSS gadget 216 also updates its stored structure 352 accordingly.

The RSS gadget 216 may be installed by default as part of an auxiliary display manifest. When there are no auxiliary display devices attached, the gadget may be disabled, and need not show up in the auxiliary display's control panel applet 354. In this example implementation, the RSS gadget 216 need not add any UI to the RSS platform, as configurations may be handled through the user interface of the auxiliary display control panel applet 354.

In one example implementation, to write the required registry information for the auxiliary display gadget, the following outline structure may be employed:
a. RSS
   i. FriendlyName=“Windows® Web Feeds” (corresponding to “RSS” in a Windows®-based system)
   ii. OnlineOnly=DWORD: 0x0
   iii. CacheAlgorithm=DWORD: 0x0
   iv. Icon=An icon representative of the RSS gadget
   v. Endpoints: e.g., a simple content format endpoint or an optional RSS endpoint

As described above, the RSS gadget 216 is also registered with the auxiliary platform, (e.g., for communicating with APIs/components 246, 356 and 358), although note that the gadget 216 need not be installed on host computer systems that do not have auxiliary displays, or on host computer systems having operating systems that do not support auxiliary displays. The RSS gadget 216 may be installed by default, and may be customizable by a device manufacturer or other entity.

Note that the first time an RSS-capable device is found, the RSS gadget 216 may display a dialog or the like to educate the user about using RSS on auxiliary devices, as well as how to interact with the RSS gadget 216, e.g., via the auxiliary display's control panel applet 354. Further note that with respect to gadget behavior, the gadget may be configured to start on user login, provided that criteria are met, e.g., that an RSS platform is up and running, that it is only run on an appropriate SKU (stock-keeping unit of the operating system), and that one or more auxiliary display devices capable of RSS support are currently installed on the host computer. In one example implementation, the RSS gadget 216 will not be enabled without each of these criteria being met.

Once enabled, the RSS gadget 216 typically runs in the background by default, as ordinarily the RSS platform is continuously running; the RSS gadget 216 will self-disable should the RSS/auxiliary platform not be present for any reason. The RSS gadget 216 may be made aware of network connectivity, e.g., such that the gadget may suspend data transfer when no auxiliary device is connected.

With respect to basic platform, gadget, and device interaction, the following outline structure may be employed, (although as will be understood, not necessarily in the order presented):
1. Utilize the operating system's RSS platform a. Load the RSS platform (e.g., DLL)
2. Distribute the user's subscribed RSS feeds to supported auxiliary devices
   a. Acquire System Feed List (subscribed feeds) from RSS Feed APIs
   b. Register for the following notifications (RSS notifications are recursive, so subscribing to root folder will get any changes)
      i. IFeedFolder.SubscriptionNotifications (new feeds added/deleted/changed, etc.)
      ii. IFeedFolder.FeedNotifications (new items added)
   c. Monitor feed list for changes
      i. Cache the state of feeds last synchronized with devices, so that it knows how to update the feed state on devices when they come back online
      ii. Update auxiliary display's control panel applet property page with feed state changes.
   d. By default, the gadget may distribute all feeds to all RSS-capable devices
      i. However, users have the option configure specific RSS feeds to be distributed to specific auxiliary devices, that is, to decide to which device or devices a given feed should go.
      ii. Store and update the feeds-to-devices mapping based on user's changes from the auxiliary display's control panel applet property.
      iii. This mapping is maintained on a per-user basis, so there the user is associated with a set of devices.
   e. Set RSS synchronization engine to download enclosures automatically (IFeed.DownloadEnclosuresAutomatically)
3. Enable auxiliary devices to render RSS feeds that users have subscribed to via the RSS platform
   a. Transcode the RSS content into simple content format
      i. Input: RSS data
      ii. Output: simple content format data
   b. Gracefully ignore format and content that cannot be rendered by the specific auxiliary device, e.g., due to device limitations. For example, the may occur when an RSS feed contains special format HTML (tables, etc.) that cannot be rendered.
   c. Media enclosures
      i. Acquire specific RSS enclosures (e.g., photos) from the RSS platform and re-encapsulate the binary data in format that auxiliary device can handle
      ii. Tag specific media enclosures (photo, video, etc.) accordingly in simple content format that require special handling on the device
      iii. Send data (e.g., binary data) to the device
   d. Based on the auxiliary device capability, the gadget determines whether a particular feed should be passed to the device. For example, if the device is a digital photo frame and has subscribed to a particular blog, the gadget will only render embedded photos, not associated text or other media.
4. Multiple users
   a. The feeds for the currently active user are synchronized only to devices associated with this user. This prevents scenarios such as a first user sending feeds to a second user's (e.g., audio player) device thereby wiping out the second user's stored feeds because the first user logged in.
   b. Fast User Switch
      i. Only applies if the device is associated with all logged in users, e.g., a laptop.
      ii. The data from the old user is removed from the device and the active user's data is synchronized to the device.
      iii. In the above audio player scenario, the audio player should only be associated with the second user, whereby when the first user logs in, the gadget recognizes that the device is not the first user's device and will not wipe the audio player's data.
      iv. Auxiliary device interaction c. Navigation-allow users to navigate and browse feeds.
      i. Preserve same folder and feed order as shown in browser component to maintain a consistent user experience
      ii. Display feed folders
         1. Users can navigate into and out of folders
      iii. Display feed titles within a folder
         1. Use icons from feed if possible.
         2. Flag feeds with new updates
         3. Display a feed's number of unread items in parentheses at the end
      iv. Display items in feed
   d. Upon selecting a feed
      i. Text
         1. Browse view
         a. Show items with associated <title> and first line of <description>
         b. Provide context menu options for showing all items or only unread items.
         c. Default: display only unread items
         d. When selecting a specific feed item, open item
         2. Detailed view
         a. Display item content in full.
         b. Provide controls for navigating text.
      ii. If item has enclosures:
         1. Determine media type using MIME tag
         2. Browse view
         a. Designate items with media enclosures with appropriate icons
         3. Detailed view-determine the appropriate format to render the enclosure
         a. Images
         i. Display appropriate metadata—captions, etc.
         ii. Scale image to fit device specs in dimensions, resolution, and color depth
         iii. Provide navigation control for next/previous images
         b. Audio
         i. Display item with audio icon
         ii. Display appropriate metadata—artists, length, etc.
         iii. Provide controls to play audio (need to integrate with firmware)-FF/RW/Pause/Play
         iv. Provide navigation control—next/previous item
         c. Video
         i. Display item with video icon
         ii. Display appropriate metadata—producer, etc.
         iii. Provide controls to play video (need to integrate with firmware)—FF/RW/Pause/Play
         iv. Provide navigation control—next/previous item
   e. Update read/unread status in UI once a feed has been opened.
5.Handling events from device
   a. ContentMissing
      i. The gadget queries the platform for missing content from the device
      ii. If a feed or item has been deleted from the platform, the gadget removes the deleted content on the device accordingly
   b. DeviceAdded
      i. Determine whether this device has been associated with the current user.
         1. If not, query user for whether they would like RSS enabled on this device
      ii. Update device with changed data, if any
   c. DeviceRemoved
      i. Do nothing

To enable scenarios like playing back podcasts, music, and video, the auxiliary device driver framework 358 may interface directly with the embedded device to utilize its hardware and firmware. For auxiliary device integration with a native device (e.g., a podcast scenario), an auxiliary device driver may write content directly to device memory, and access firmware functionality that provides playback control.

From a source provider's perspective, the auxiliary display platform and RSS gadget enables software vendors or content publishers to utilize RSS to distribute and install new gadgets for users. Furthermore, it also increases the usage scenarios of SideShow gadgets, as content providers and software vendors can now provide content to SideShow devices from the web, in addition to the personal computer locally. This may include specifying and register new MIME types, including a MIME type for simple content format (e.g., Content-type: text/x-simple_content_format) and a MIME type for auxiliary installation data (e.g., Content-type: application/gadget).

To facilitate the way in which RSS entities may distribute new gadgets, that is, via RSS feeds, the entities need only publish RSS feeds with gadget installation metadata enclosed. For example, a gadget enclosure may contain the title, icon, supported endpoints, and so forth for the new gadget. Thereafter, the RSS synchronization engine (e.g., part of the RSS platform 350) automatically downloads simple content format and/or gadget enclosures.

From the perspective of building and distributing new auxiliary gadgets using RSS, consider a software developer working for a company such as one that owns a site zzzmovies.com. To release a “movie” gadget that enables users to see real-time movie information based on each user's location, the developer may embed special data (e.g., metadata about the movie gadget and real-time information in the simple content format) in zzzmovies.com's RSS feed, using enclosures. When received, the RSS gadget parses this simple content format data, and installs a movie gadget when a user first subscribes to the feed.

FIG. 4 represents one such illustrative example, e.g., in which an auxiliary device such as a cell phone-based auxiliary display device 460 presents movie listings from a site, zzzmovies.com, that is, obtained via its web server 462. In this example, consider that the user already reads various RSS feeds (X, Y, Z) from various web sites (servers) 464 on the cell phone 460 via the RSS gadget 216. This state of having previously subscribed to feeds X, Y and Z is generally represented in FIG. 4 by the arrow labeled with circled numeral one (1).

In this example, some time thereafter, such as when browsing zzzmovies.com's website, the user subscribes to a new feed W that contains a zzz movie gadget enclosure 470 from the zzzmovies.com server 462. Upon such a subscription request, the RSS gadget 216 is notified (e.g., via the RSS platform 350) and sees the <gadget> enclosure. In general, this is represented in FIG. 4 by the arrow labeled with circled numeral two (2). In response, the RSS gadget 216 will install the zzz movie gadget 470 (the arrow labeled with circled numeral three (3)). Note that some policy and/or user approval may be required to allow the installation.

After installation, the zzz movie gadget 470 may be loaded and run, and will subscribe to its own feed W using the RSS platform 350, and after this point may operate independently of the RSS gadget 216, as generally represented in FIG. 4 by the arrow labeled with circled numeral four (4). Via the feed W, the zzz movie gadget 470 may receive raw content in the simple content format through enclosures, but as described above, may alternatively include conversion code to convert the RSS feed content to a format the device can understand, such as a content that best matches the feed content to the device capabilities.

An alternative implementation may have the RSS gadget 216 subscribe to the W feed, and manage the data for the zzzmovie gadget. In this implementation, the RSS gadget 216 is effectively running the zzzmovie gadget.

Note that once installed, the zzz movie gadget 470 need not be installed each time, but rather its installation data in the metadata having corresponding information already in the registry may be used to load and run (i.e., instantiate) an instance of the gadget whenever the same metadata is detected in the RSS feed. For example, if the gadget 216 recognizes that metadata has previously been processed into the installation data in the registry, the installation data may be read back from the registry (or the current metadata may be converted to equivalent installation data) to enable (e.g., load and run) an instance of the corresponding gadget to handle the content.

As can be readily appreciated, although it is feasible for the RSS gadget to handle the RSS content instead of enabling another gadget for that purposes, the model exemplified in FIG. 4 is advantageous for a number of reasons, including that the management of the new gadget 470 is de-coupled from the RSS gadget 216, even though both use RSS as the data delivery mechanism. Among other benefits, this model prevents duplicate showings of feed W in two places, e.g., once in the cell phone's RSS menu, and once on its own movie menu. The new gadget 470 may also handle its own data interactions with host server, whereby the RSS gadget 216 need not have to have logic, conversion code and so forth to process the additional (non-gadget-related) enclosures received from the W feed. Note that if the RSS gadget 216 stops running for any reason, the movie gadget 470 will also stop.

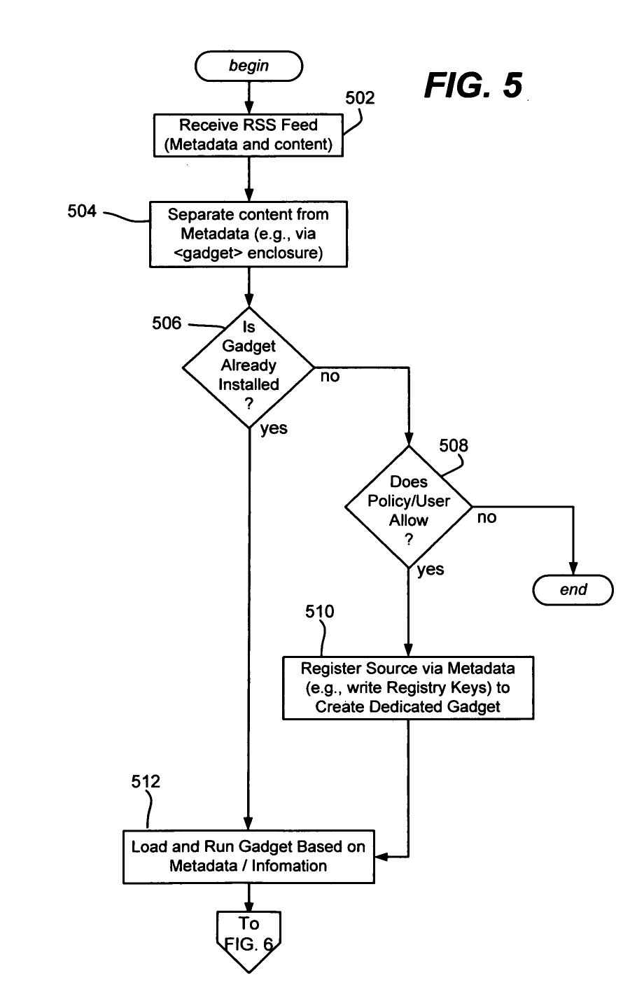

FIG. 5 shows example logic that may be taken by the RSS gadget 216, in which the first time that the user subscribes to a feed and receives the feed (step 502) containing the appropriate metadata, e.g., a <gadget> enclosure, as evaluated via steps 504 and 506, the user is given an opportunity to install a gadget for that feed's content. For example, step 508 represents policy and/or user consent being evaluated, e.g., a user interface of the RSS gadget 216 may prompt the user to indicate that the feed has some [×] gadget that can work with the device, and inquiring whether the user would like enable it. If not, the process is ended. Note that at step 506, if the gadget is already installed, e.g., this is not the first time that the user subscribed to the RSS feed, or the user installed it in some other way, the process advances to step 512 to user the already-installed gadget.

If the user/policy allows the enabling of the gadget, e.g., the user consents at step 508, the RSS gadget proceeds to install the new gadget at step 510. In one implementation, this may include writing the necessary registry information based on the metadata in the <gadget> enclosure, opening the auxiliary display's control panel applet and prompt user to assign the gadget to the appropriate devices, and associating this specific feed with the newly installed gadget. This ensures that subsequent enclosures of the appropriate format (e.g., simple content format enclosures) are only delivered to this gadget. The new gadget may be registered with the auxiliary platform. After installation completes, the process continues to step 512.

At step 512, the RSS gadget 216 loads and runs the installed gadget. Note that while the gadget 216 could itself handle the feed content, in one implementation, the RSS gadget 216 does not subscribe to this feed, and does not manage this feed, instead letting the newly loaded and run gadget receive the feed content. Among other reasons, this helps avoid user confusion, e.g., where the feed shows up on the user's device RSS menu as well as showing a separate gadget on the device. Further, the loaded gadget will handle its own interactions, data requests, and so forth with its host web server, which is advantageous when it is independent of the RSS gadget 216 that handles RSS feeds from possibly many data sources.

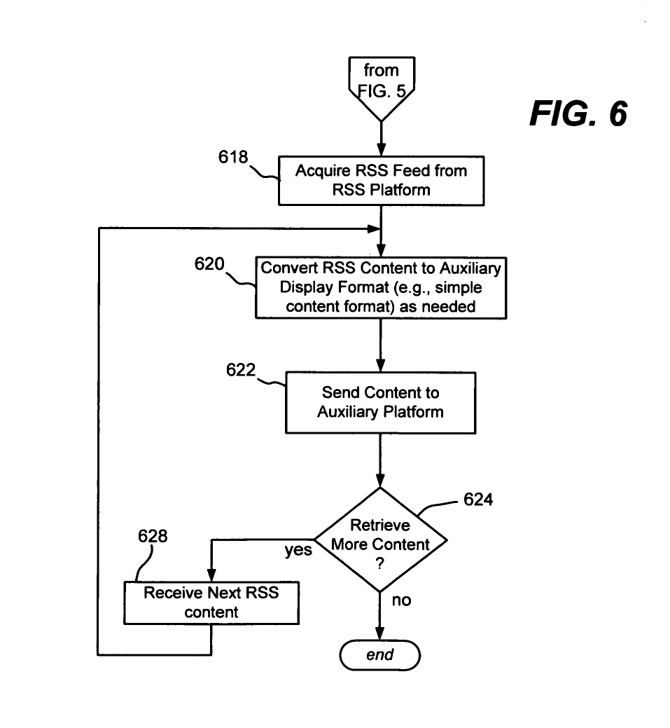

As generally represented in the flow diagram of FIG. 6, the (previously or newly installed) gadget that was loaded and run via FIG. 5 has the responsibility to acquire its specific feed from the RSS platform (step 618), and handle data interactions with host web server (steps 624 and 628). The communication with the auxiliary platform is generally to send any content extracted from the RSS data (e.g., in simple content format enclosures) to the RSS platform (step 622), after performing any content format conversion at step 620 as necessary for the auxiliary device to understand the format.

The following information is directed to some example user interface concepts, using pages to present the user with information, and where example RSS fields are shown by enclosing them in <brackets>:

```
Title bar: RSS Folders
This UI page displays available RSS folders cached on the
auxiliary device.
  Folders with feeds with unread items may be in bold
  Folders may show number of unread feeds in parentheses at
  the end
  Folders with no unread feeds may be in plain text
  Selected folder may be highlighted
Title bar: RSS Feeds - [Folder name]
This page displays the user's subscribed feeds for this
auxiliary device.
  Feeds with unread items may be in bold followed by the
  number of unread items in parentheses
  Feeds with no unread items may be in plain text
  Feeds with recognized media enclosures with have special
  icons at the end, one for each type
    Recognized media: e.g., photos, music, audio, video
Title bar: [Feed name = <channel title>]
This page displays a top-line view of the cached items for
this feed
  Show item <title> in bold
    Title that is too long may ellipsis
    Non-existing title may be replaced by first line of
    item <description>
  Show first line of item <description>
    Line may ellipsis or truncate
    Non-existing description field may be left blank
  Items may be displayed from top to bottom in most
  recently updated order.
Title bar: [Feed name]
This page displays the cached items on the device.
Media type: text
  Show item title in bold
    Title that is too long may ellipsis
  Show last update timestamp
    Time stamp may ellipsis
  Show feed content as device is capable of rendering
    Content may scroll up/down if it does not fit on the
    screen
    Text
Title bar: [Feed name]
Media pages only display enclosures of specific user-defined
media types. It does not render text or any other media
associated with the feed
Media type: images
  Show item title in bold
    Title that is too long may ellipsis
  Show last update timestamp
    Time stamp may ellipsis
  Show enclosure title (if available)
    Enclosure title may ellipsis
  Show image content as device is capable of rendering
    Render image at settings supported by device
    (resolution, color depth, etc.)
    Scale image to fit display dimensions if necessary
Title bar: [Feed name]
Media type: mixed audio and text
  Show item <title> in bold
    Title may be proceeded by an audio icon that indicates
    this item enclosures audio content, e.g., music or
    podcast
    Title that is too long may ellipsis
    Non-existing title may be replaced by first line of
    item <description>
  Show first line of item <description>
    Line may ellipsis (or truncate, whichever is cheaper)
    Non-existing description field may be left blank
  Items may be displayed from top to bottom in most
  recently updated order.
Basic two line displays will not support RSS well, and RSS
information is arguably less critical and readable than email
or calendar information in two lines. For two-line displays:
  First line
    Show feed name - item time stamp.
    Ellipsis if the line does not fit; scrollable
    left/right
  Second line
    Show item name - item description
    Ellipsis if the line does not fit; scrollable
    left/right
    Gracefully reject formatting and media except text
  Navigating feeds
    No folder information shown, as it is not critical
    The gadget will flatten the folder/feed tree and
    display items sequentially on a basic display
    Up/down moves to next item in feed. When a feed runs
    out of items, the next feed may be displayed. When a
    folder runs out, the next folder's first feed's first
    item may be displayed, and so on.
```

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
processing data received from a source, including processing metadata associated with the data, the metadata corresponding to information for handling content associated with the data; and
using the metadata information to enable a gadget to handle the content, including providing at least part of the content to an auxiliary display platform.

2. The computer-readable medium of claim 1 wherein processing the metadata comprises determining whether information corresponding to the metadata is in a registry.

3. The computer-readable medium of claim 2 wherein processing the metadata indicates that the information corresponding to the metadata is in the registry, and wherein using the metadata to enable the gadget comprises loading and running a gadget based on the information in the registry.

4. The computer-readable medium of claim 2 wherein processing the metadata indicates that the information corresponding to the metadata is not in the registry, and wherein using the metadata to enable the gadget comprises writing information corresponding to the metadata into the registry to install the gadget, and loading and running the gadget.

5. The computer-readable medium of claim 1 having further computer-executable instructions comprising converting the content from one format to another format for providing the at least part of the content to the auxiliary display platform.

6. The computer-readable medium of claim 1 wherein the data source corresponds to an RSS feed, and having further computer-executable instructions comprising receiving additional content, including one or more of audio, video, images, text, one or more MIME types, or other content from the RSS feed.

7. The computer-readable medium of claim 1 wherein using the metadata information to enable the gadget comprises running one gadget to create at least one virtual gadget by writing to a registry.

8. The computer-readable medium of claim 1 wherein using the metadata information to enable the gadget comprises having one gadget distribute and install executable software code for another gadget.

9. In a computing environment having a data source and a computer system that communicates with an auxiliary device to display content on the auxiliary device, a method comprising:
obtaining received data at a gadget;
processing metadata included among the received data, the metadata corresponding to another gadget that is capable of handling content associated with the received data;
determining from the metadata whether the other gadget needs to be installed, and if so, installing the other gadget;
running the other gadget; and
receiving content via the other gadget, including outputting at least part of the content for consumption by the auxiliary display device.

10. The method of claim 9 wherein determining from the metadata whether the other gadget needs to be installed comprises accessing data in a registry.

11. The method of claim 9 wherein the other gadget needs to be installed, and wherein installing the other gadget comprises writing information corresponding to the metadata to a registry.

12. The method of claim 9 wherein outputting at least part of the content for consumption by the auxiliary display device comprises converting the content from one format to another format.

13. The method of claim 9 wherein obtaining the data comprises communicating to subscribe to an RSS feed.

14. In a computing environment having a host computer and an auxiliary device that couples to the host computer, a system comprising:
a platform that receives distributed data from data distribution sources;
a distribution gadget coupled to the platform such that the distribution gadget processes the distributed data received at the subscription platform;
an installer mechanism associated with the distribution gadget, the installer mechanism configured to install a specific gadget as needed for a specific data source based on information within a set of the distributed data received from the specific data source; and
an auxiliary display platform that receives content from the specific gadget, the content corresponding to the distributed data received from the specific data source.

15. The system of claim 14 wherein the computing environment comprises a plurality of auxiliary display devices, and further comprising a mapping mechanism that relates the specific feed to a subset of the auxiliary display devices.

16. The system of claim 14 wherein the data distribution sources are RSS data sources that correspond to at least one of blog/RSS consumption, blog/RSS creation, a digital photo frame, a podcast, and a Sidebar gadget.

17. The system claim of claim 14 wherein the auxiliary device understands a first data format, and further comprising, means for converting data from another data format to the first data format.

18. The system claim of claim 17 wherein the specific gadget is associated with the means for converting data from another data format to the first data format.

19. The system claim of claim 14 wherein the installer mechanism installs the specific gadget by writing information to a registry that corresponds to information received from the specific data source.

20. The system of claim 19 wherein the information received from the specific data source is contained in an enclosure related to the gadget.
